(19) United States
(12) Patent Application Publication
(10) Pub. No.: US 2010/0306326 A1
(43) Pub. Date: Dec. 2, 2010

(54) METHOD FOR TRANSMITTING APPLICATION MESSAGES BETWEEN COMPUTOR NETWORKS

(76) Inventor: Sergey Ageyev, Vinnitsya (UA)

Correspondence Address: WEINER & BURT, P.C., 635 N US-23, POB 186, HARRISVILLE, MI, 48740, US

(21) Appl. No.: 12/597,749

(22) PCT Filed: Apr. 10, 2008
(86) PCT No.: PCT/UA08/00024

§ 371 Date: Mar. 18, 2010

(30) Foreign Application Priority Data
May 3, 2007 (UA) A 2007 04860

(51) Int. Cl. G06F 15/16

(52) U.S. Cl. 709/206

(57) ABSTRACT

The inventive method for transmitting application messages between computer networks relates to information engineering and computer information processing. The method is carried out by means of an additional hardware-software input unit which is positioned between the external and internal networks of a computerized system and is used as a unit in the form of a protective gateway (gateway) which transmits information between networks. The inventive method consists in waiting a message from the external network at the input of an external gateway network interface, in loading the message in the core memory of the gateway and in transmitting the message to the internal network of the gateway via the internal network interface. The messages are received via the input gateway network interface in the form of a packet sequencing according to the gateway receiving protocol. The message is loaded into the gateway core memory prior to the reception of the entire message, only one message being loaded into the gateway core memory at one time. The message data is transmitted from the core memory via the internal network interface by means of the gateway in the form of a packet sequencing according to the gateway transfer protocol. Said method ensures the operational stability of the software for internal networking.

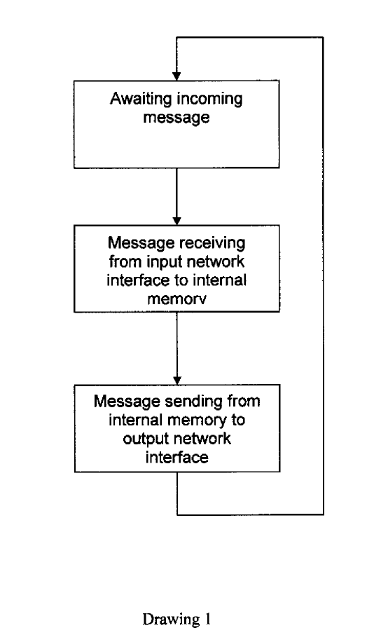

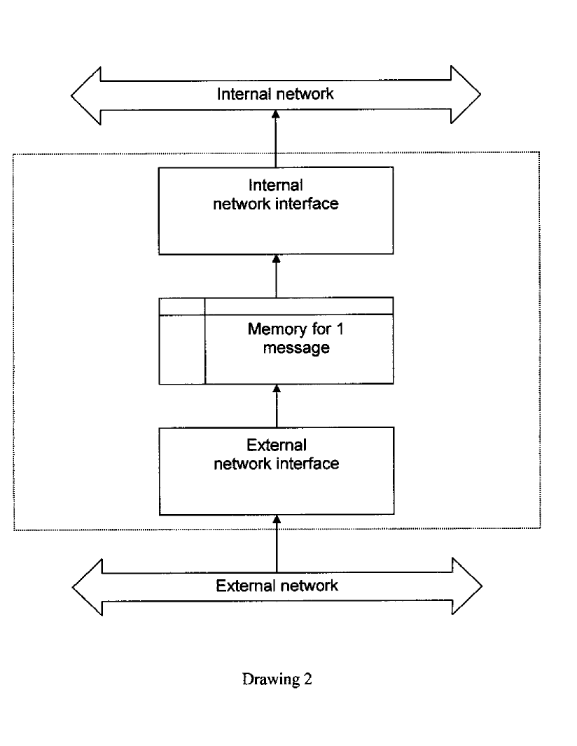

### 1. FIELD OR THE INVENTION

The proposed method for transmitting application messages between computer networks relates to information technologies and computer processing of information.

The method is intended for protection from attacks that use vulnerabilities in the program code of processes in information processing nodes (servers or groups of servers) of externally accessed automated information processing systems (further referred to as AIPS).

The method can be implemented as information security device for computer networks (further referred to as networks). The device implementing the method is intended to be used in externally accessed automated information processing systems (severs or groups of servers) for protection from attackers that have access to AIPS from the network used for communication with AIPS users or a definite group of users (further referred to as external network).

### 2. TECHNICAL FIELD

Currently, there exist several approaches to internal network protection [1,2,3,4].

2.1. Physical separation of networks (data transfer using external data storage device)

This solution implements physical separation between external and internal networks with an external data storage device being used for data transfer via physical device reconnection.

The data to be transferred between networks (AIPS application messages) is stored on external storage devices as files, those external storage devices being periodically physically attached to dedicated computers in external and internal networks for data transfer.

This method is widely used when high level of security assurance is needed for internal network. In this case attacking a computer, located in external network (even gaining the full control over it) does not give the attacker new possibilities, because access to internal network is physically denied. In such case the only way of further attack for an attacker is to damage the file structure on external storage device in hope to trigger vulnerabilities in software component that support the file system operations on the computer in internal network.

The main drawback of this method is a big time interval to manually transfer the data between networks via external storage device (typically, about several minutes). Also, even if this method is used, an attack is still possible via malicious file system damage in order to trigger vulnerabilities in software code supporting the file system. Such kind of attack can be prevented via mandatory file system verification before external data storage device is mounted on the computer in internal network.

An improved version of such method is known: systems with hardware configuration commutation. These systems implement an automated system for data transfer with hardware configuration commutation (including hardware switching of storage devices between computers in external and internal networks). This kind of implementation is in fact an automated version of previous (manual) implementation with main difference being in usage of periodical hardware commutation of the data storage device instead of manual (re)attachment. This kind of implementation significantly decreases the time interval for data transfer operation, but even in this case it still takes about several seconds (or tens of seconds) even for short messages transfer (about several kilobytes in size). This is because most of the time is spent on read/write file operations on external data storage and on mounting/unmounting operations for the file system (and also on the file system verification after mounting).

All these factors complicate (or even make impossible) the implementation of the systems that need “OnLine” operations.

2.2. Network Protection

Network protection systems perform analysis on packets incoming from external network with a goal to filter (and approve to transfer) only those packets that are allowed to enter the internal network.

Network firewall is a network protection system, that enforces rules, defined by the system administrator. Pure network firewalls [2,4] usually function at the network protocol layer and can implement restrictions on packet types, used by that protocol (mostly filtering is used to exclude packets intended to establish connection with internal network services, access to which is not allowed from the external network). The examples of such kind of systems are Network Firewalls and network routers with packet filtering options (IP Filters).

Intrusion prevention system is a system for protection of networks which implement packet filtering with a goal to find a sign of potential attack. Intrusion prevention system works at the network protocol layer [2,4] and analyses packet content and packet context. The analysis criteria are based on the known (at the moment of analysis) attack properties and, possibly, on some kind of empiric suppositions about possible future attacks. The database, containing attack criteria, is constantly or periodically updated when new attacks/vulnerabilities are found (similar to antivirus database). The example of such kind of system is Intrusion prevention system (IPS).

Proactive filtering systems perform analysis of application-level messages, delivered by the known application level protocols in order to find signatures of potential attacks.

Proactive filtering systems [2] work at the level of content of application messages transferred via common network protocols in order to find signatures of potential attacks. The analysis criteria are based on the known (at the moment of analysis) attack properties and, possibly, on some kind of empiric suppositions about possible future attacks. The database on attack criteria is constantly or periodically updated when new attacks/vulnerabilities are found (similar to antivirus database). The systems operate with the data of well-known application level protocols.

The example of such kind of system is e-mail filter which protects from viruses distributed via e-mail.

### 3. SUMMARY OF THE INVENTION

3.1. Closest existing solution and its drawbacks

The closest existing solution (analogue) of the proposed method is a network protection method that is implemented by a hardware firewall.

Drawbacks of the Existing Method:

All the network protection systems are based on the well-known network communication protocols. Therefore, all of them require implementation of said protocol (e.g., TCP/IP). As said protocol is relatively complex, the implementation of such protocol in network protection devices may contain program vulnerabilities (software errors), which, in turn, makes network protection systems vulnerable to attacks that use such vulnerabilities. As a result, an intruder may use that vulnerability to gain control over the network protection device and deactivate the protection function or even use network protection device as a “foundation” for future attacks on the system being protected.

Also, firewall and intrusion prevention system have an additional drawback: filtering they implement is based on the packet level of underlying network protocol. As a result, no matter how deeply packet content and (or) packet context is analyzed, the protocol itself remains unchanged. As network protection system is intended to allow information transfer, some amount of network packets from external network will pass through (possibly, with minor modifications) to internal network. Again, the AIPS itself is intended to serve users from external network, so some communication packets must be allowed to pass from external network to internal one. The AIPS software code responsible for processing the packets that have passed filtering, can still contain vulnerabilities which may lead to attacks that are “transparent” for said network protection systems.

Intrusion prevention systems and proactive filtering systems have an additional drawback, caused by the use of database of known vulnerabilities (and, possibly, by some empiric suppositions about potential future attacks). As all possible program vulnerabilities (software errors) of AIPS are not known beforehand, this method can prevent only known attacks and very limited amount of unknown attacks. In particular, such method of protection cannot guarantee protection from “zero day” attacks.

Software network protection systems are program modules, which are installed in a protocol implementation stack of the operation system and have the firewall-like functionality.

Along with the common drawbacks of filtering methods (listed above) it is important to note that the solutions of this kind function under the control of the operation system they are intended to protect, so they are subjected to general vulnerabilities of the operation system they are installed into.

Hardware network protection systems are dedicated devices, which work as a gateway between networks and implement network protection system functions (firewalls, packet filters, packet analyzers, intrusion prevention systems).

After a closer look, solutions of this type function under the control of special operation systems. As these solutions have to implement a general-purpose network protocol, they still require a large amount of the program code. This, in turn, leads to the impossibility of formal verification of program code correctness.

As a result, there are vulnerabilities in the program code of special operation systems used in hardware network protection solutions, which is confirmed by periodic software updates issued to said program code by solution vendors.

Therefore, hardware implementation itself does not change the situation: in addition to common drawbacks of the filtering methods (listed above) it is important to note that an intruder may potentially use vulnerabilities in the special operating system of hardware protection solution to gain control over said solution.

The usage of existing solutions (analogues), listed above, may significantly increase the effort spent by the intruder in order to find a relevant software vulnerability, but still they cannot prevent all possible attacks.

One must note that drawbacks in the existing solutions, listed above, are relevant to attacks that use vulnerabilities in the program code. For other kinds of attacks (which are not considered in this research) this solution may produce acceptable protection (for example, protection from “Deny-of-service” attacks).

3.2. The proposed solution

The proposed method of message transfer is free from the listed drawbacks due to:

the usage of specialized transmission protocol, which is simplified and oriented to transferring single application-level message at a time;

the usage of the dedicated intermediate hardware gateway device, which implements said protocol and operates under the control of the program code which is analyzed by formal methods;

implementation of the message transfer between networks by retranslation of the message received from in-device memory and only after processing of the incoming message data confirms the fact of completed message reception;

the device performs procedures of information exchange with internal network in a stabilized way with no direct influence of external network interfaces on internal network interfaces during information exchange.

The subject of the invention is the proposed method for transferring application messages between computer networks, that includes the following stages:

waiting for a message from the source network at the input of the network interface of the gateway,

loading the message into the own core memory of the gateway,

sending the message from the own core memory of the gateway via the output network interface to the target network.

Comprising:

messages being received by gateway from input network interface as a sequence of packets according to the gateway receiving protocol,

message being loaded into the gateway internal own core memory until the entire message is received: comprising only one message at a time is loaded into the own core memory,

message being transmitted by the gateway from its internal own core memory to the output network interface as a sequence of packets according to the gateway transmission protocol.

3.3. Technical result

The technical result achieved by implemented the method proposed is a stable conditions of operation for internal network of AIPS. This prevents attacker's ability to reproduce the conditions need to trigger software vulnerability in AIPS network communication program code.

The proposed method allows simplifying algorithms used in network gateway and radically reduces amount of program code need to implement it.

The technical result achieved because during operation network gateway receives an incoming message on input network interface as a sequence of packets according to special protocol (further referred to as gateway receiving protocol) and load it in own core memory. During message receiving, the output interface does not affect the ability of gateway to follow the gateway receiving protocol.

After message is completely received, the gateway starts the process of transmitting (retranslation) of message data from its own core memory via output network interface as sequence of packets according to special protocol (further referred to as gateway sending protocol).

During message transmission, the input interface does not affect the ability of gateway to follow the gateway sending protocol. After message transmission procedure is completed, the network gateway returns in an idle state awaiting a new incoming message. According to this, the external network communicates with the internal network in a single way: through transmission of application message by network gateway itself from the gateway's own core memory via gateway sending protocol.

The method implementation schema is shown on drawing 1.

3.4. Comparison to analogue (summary)

The main differences between the analogue and the proposed method are listed in table 1.

TABLE 1

| Criteria | Analogue (existing solution) | Proposed solution |
|---|---|---|
| Location | Between networks | Between networks |
| Protocol used for information exchange | General purpose network protocol, oriented on | Protocol is specialized on transfer |
| | support for many simultaneous data transfer sessions | of one application message at a |
| | | time. |
| Protocol complexity | High | Low |
| Number of application messages in | Many | One |
| processing at a time. | | |
| Network protection method | Prevention of known attacks based on attack | Attack prevention via internal |
| | properties | network operation mode |
| | | stabilization |

### 4. POSSIBLE EMBODIMENT

The method is implemented by additional hardware & software device, which is located between external and internal networks of AIPS, and the device implements functions of protection network gate, which transfers information between networks.

The device performs as an application-level firewall and intended to protect the server (or servers) of AIPS (or internal network of AIPS) from attacks based on software vulnerabilities (errors) in network operation program code, that performs information exchange between server (or servers) of APIS and external network.

Vulnerabilities (errors) can exist in a program code of operation system, which implements general propose network protocol stack, in a program code of network information exchange of system services and(or) in a application(s) program code of network information exchange between application(s) and users of AIPS.

The device structure is shown on drawing 2.

The protection network gate is hardware & software device which:

1). is located between networks;

2). transfers information between networks by means of retranslation of application-level messages;

3). implements special protocol for application messages transfer between networks, witch is intended to transmission one message at a given point of time;

4). operates under control of its own software, the correctness of protocol implementation in it can verified by formal methods.

Network gateway has two network interfaces, which connect it to the external and the internal network. The data transfer protocol is designed for the transmission of a single message in a single cycle of operation (gate protocol).

The network gateway contains its own core memory that can store the single application-level message. All gateway operation cycles are similar and alike (the gateway does not change its internal state in the way that can affect protocol implementation), so as a protocol implementation device, gateway acts as a stateless component between messages.

Those factors allow to maintain the amount of software code inside the gateway in bounds, which make relatively easy to perform its formal analysis to guarantee that gateway follow the gateway protocols during the information exchange with the AIPS internal network (or a single server if it is connected directly to the gateway).

Due to guarantee that the gateway follows gateway protocol when it performs the information exchange with an AIPS internal network, all information exchange cycles in internal network are similar and repeatable.

The proposed method allows to simplify algorithms used in the network gateway and radically reduces the amount of the program code to implement it. The typical amount of a software code (used by the working prototype) is about 300 kilobytes of a source code (about 20 kilobytes of a binary machine code). The network gateway software may be implemented without a usage of hardware interrupts (or with the very limited usage of them).

The network gateway does not use any operation system (just a software code loader). The gateway software code may be located in the read-only memory (ROM) and can operate when the code is located in the read-only memory.

Those factors allow to maintain an amount of a software code inside a gateway in bounds, which make relatively easy to perform its formal analysis to guarantee that a gateway follow gateway protocols during the information exchange with the AIPS internal network (or a single server if it is connected directly to a gateway).

As an evidence of a possibility of such formal analysis, operation systems of smart cards can be taken, which also contains microprocessor and “micro” operation systems with an amount of binary machine code also about 20 kilobytes, and which has achieved high security assurance levels (Evaluation assurance level [1,5]) after formal analysis of program code [6].

### 5. PRACTICAL APPLICABILITY AND USEFULNESS

In fact, the method provides the stability of operation conditions for the internal network for AIPS. This effectively prevents attacker's ability to reproduce conditions that are needed to trigger vulnerabilities in the AIPS program code that performs the network information exchange with clients, because of all data transfer operations to the internal network are performed by the gateway and an attacker cannot affect this process.

In the case when AIPS clients need to use general-propose network protocols to access AIPS functions, the external network can be attached to the special external protocol conversion node, which is attached to the external network from one side and to the network gateway on the other side. The protocol conversion node uses the standard software (for example, using a general-propose operation system) and receives/sends application messages to clients using general-propose network protocols and sends/receives them to / from the internal network via a gateway using the network gateway protocol.

In the case when AIPS servers need to use general-propose network protocols to provide AIPS functions, the internal network can be attached to the special internal protocol conversion node, which is attached to the network gateway from one side and to the internal network on the other side. The internal protocol conversion node operates in the similar way that external protocol conversion node described above.

In the case when the bi-directional data exchange need between the internal and the external networks, the gateway can be implemented as a single half-duplex or as two simplex nodes which are connected (for example, to protocol conversion nodes) in the opposite-parallel scheme.

In the case when the high bandwidth need, it is possible to connect several gateways in parallel with additional node (nodes) in the external and the internal networks that balances a workload between them.

When the external protocol conversion node is used, even if an attacker realizes a successful attack on the protocol conversion node and gains full control on it, the only way to transmit a message to the internal network is still correct transmission of an application message to a gateway via the gateway protocol (an attacker could do this before the AIPS user). After a message been sent to a gateway, an attacker has no any means to affect the process of a message transmission from a gateway to the internal network because of this is not a subject of a gateway protocol, which is guaranteed to be implemented by a gateway.

As a result, the attack on software vulnerabilities in the network information exchange program code does not give to the attacker any way to control conditions of operations in the internal network.

The gateway brings in the data transfer process relatively small delay, about the twice time to transfer a message by the gateway protocol via the network interfaces.

Presently, the bandwidth of typical network interfaces is about 1 Gbits per a second (for example Gigabit Ethernet) or even more (with other standards). In fact, the delay for messages with several kilobytes in size can be few milliseconds, even with 100Mbits per a second network interfaces (reached on the working prototype). All those parameters allow to use the network gateway in AIPS that operates in “online” mode.

### 6. REFERENCES

1. “ENCLAVE SECURITY TECHNICAL IMPLEMENTATION GUIDE”. Developed by DISA for the DOD. DISA Field Security Operations, 28 Jul. 2005. Version 3, Release 1. UNCLASSIFIED (2005).
2. “CYBER SECURITY PROGRAM. CYBER SECURITY ARCHITECTURE GUIDELINES”. U.S. DEPARTMENT OF ENERGY. DOE G 205.1-1. Office of the Chief Information Officer, 3-8-01 (2001).
3. “New technologies in information security”. Dmitry Zarahovich. “CEBIT” Antivirus laboratory. “Security in information and telecommunication systems” (VIII International conference, 11-13 May 2005, Kiev, Ukraine). DSTSZI Of Ukraine. SCIS Of Ukraine. UDK 681.3.06. Printed by PE “EKMO”, Ukraine.
4. “Information Security: Defensive Battle”. Avi Chesla. INFORMATION SECURITY MANAGEMENT. JANUARY/FEBRUARY 2004.
5. ISO/IEC 15408-1:2005. Information technology—Security techniques—Evaluation criteria for IT security.
6. German Zoned Products List. Bundesamt für Sicherheit in der Informationstechnik TL03305. December 2005.

1. A method for transferring application messages between computer networks, comprising the steps of:
interposing between a source computer network and a target computer network a network gateway having its own core memory, an input network interface, and an output network interface;
waiting a message from said source computer network at an input of said input network interface of said network gateway;
loading said message into said core memory of said network gateway; and
transmitting said message from said core memory of said gateway via said output network interface to said target computer.

2. The method of claim 1, including the step of:
receiving messages received by said gateway from said input network interface as a sequence of packets according to a gateway receiving protocol.

3. The method of claim 1, including the step of:
loading the message into said core memory of said network gateway until the entire message is received.

4. The method of claim 2, including the step of:
loading the message into said core memory of said network gateway until the entire message is received.

5. The method of claim 1, including the step of:
loading only one message at a time into said core memory of said network gateway.

6. The method of claim 2, including the step of:
loading only one message at a time into said core memory of said network gateway.

7. The method of claim 3, including the step of:
loading only one message at a time into said core memory of said network gateway.

8. The method of claim 4, including the step of:
loading only one message at a time into said core memory of said network gateway.

9. The method of claim 1, including the step of:
transmitting the message by said network gateway from said core memory of said network gateway to said output network interface as a sequence of packets according to a gateway transmission protocol.

10. The method of claim 2, including the step of:
transmitting the message by said network gateway from said core memory of said network gateway to said output network interface as a sequence of packets according to a gateway transmission protocol.

11. The method of claim 3, including the step of:
transmitting the message by said network gateway from said core memory of said network gateway to said output network interface as a sequence of packets according to a gateway transmission protocol.

12. The method of claim 4, including the step of:
transmitting the message by said network gateway from said core memory of said network gateway to said output network interface as a sequence of packets according to a gateway transmission protocol.

13. The method of claim 5, including the step of:
transmitting the message by said network gateway from said core memory of said network gateway to said output network interface as a sequence of packets according to a gateway transmission protocol.

14. The method of claim 6, including the step of:
transmitting the message by said network gateway from said core memory of said network gateway to said output network interface as a sequence of packets according to a gateway transmission protocol.

15. The method of claim 7, including the step of:
transmitting the message by said network gateway from said core memory of said network gateway to said output network interface as a sequence of packets according to a gateway transmission protocol.

16. The method of claim 8, including the step of:
transmitting the message by said network gateway from said core memory of said network gateway to said output network interface as a sequence of packets according to a gateway transmission protocol.

17. The method of claim 1, including the step of:
operating said network gateway under control of its own software.

18. The method of claim 2, including the step of:
operating said network gateway under control of its own software.

19. The method of claim 3, including the step of:
operating said network gateway under control of its own software.

20. The method of claim 16, including the step of:
operating said network gateway under control of its own software.
